(19) United States
(12) Patent Application Publication
(10) Pub. No.: US 2015/0323160 A1
(43) Pub. Date: Nov. 12, 2015

(54) SMARTPHONE LIGHT PROJECTION DEVICE WITH EFFECTS AND AMBIENT NOISE SYNCHRONIZATION

(71) Applicant: James R. Duguid, Indianapolis, IN (US)

(72) Inventor: James R. Duguid, Indianapolis, IN (US)

(21) Appl. No.: 14/709,738

(22) Filed: May 12, 2015

Related U.S. Application Data
(60) Provisional application No. 61/991,724, filed on May 12, 2014.

(51) Int. Cl. F21V 17/00; F21V 14/04

(52) U.S. Cl. CPC F21V 17/002; F21V 14/045

(57) ABSTRACT

An entertainment accessory device for use with an electronic device's built-in light source for projecting light effects onto a surface, such as onto a ceiling, wall or car interior. The entertainment device can operate in conjunction with application software loaded into a smartphone's computer memory that fluctuates the light emitted by the smartphone in reaction to the volume, frequency, or pitch of music played through or detected by either the smartphone or an independent audio source. The entertainment device can include multiple projection members than can be set to multiple configurations to alter the light effects.

### CROSS REFERENCE TO RELATED APPLICATION

This application claims the benefit of U.S. Provisional Application Ser. No. 61/991,724 filed May 12, 2014 which is hereby incorporated by reference.

### BACKGROUND

This invention relates to the field of entertainment accessories for electronic devices and smartphones that are equipped with LED lights. The disclosed device enables the electronic device to project colors and/or light effects onto surfaces such as walls and ceilings of rooms and automobiles substantially different than could be projected without the device and optionally in coordination with ambient noise or music.

Venues such as concerts and dance clubs can feature technology that coordinates light with ambient music via the use of strobe, laser, or other lights. This equipment is often unwieldy, expensive, and difficult to operate and is therefore generally only used for commercial purposes. In order to import the look and feel of concerts and dance clubs into a residential setting, a low cost, portable, and easy to operate device would be beneficial.

Thus, there is a need for improvement in this field.

### SUMMARY

Disclosed is an entertainment device accessory for use with an electronic device's built-in light source for projecting light onto an exterior surface, such as onto a ceiling, wall, or car interior. The disclosed device can alter the color, direction, and/or pattern of light emitted from the electronic device's light source to create various light effects. The entertainment device can be used to display logos or other graphic designs onto surfaces.

The entertainment device can operate in conjunction with the electronic device to alter the intensity and/or duration of light emitted from the light source. For example, if the electronic device is a smartphone, the smartphone can include software that alters the output of the light source in response to sounds sensed via the smartphone's microphone. Application software of the smartphone can then activate the smartphone's light in response to certain aspects of sensed music such as the tempo, loudness, and/or pitch. An example software that uses a smartphone's microphone and coordinates it with some function of the smartphone is iStrobe™ (available at https://itunes.apple.com/us/app/music-strobe-led-lightlight/id393773873).

In an exemplary embodiment, the entertainment device includes multiple lenses of different colors or effects integrated onto a rotating dial, enabling the user to to create multiple different types of lighting projections and effects. The entertainment device can further include electromechanical actuators to automatically alter or switch between lenses or combinations of lenses. The entertainment device can automatically switch in response to a command received from the electronic device or via an integrated sensor, such as a microphone.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of an electronic device.

FIG. 2 is a perspective view of an exemplary embodiment of an entertainment device used in conjunction with the electronic device of FIG. 1.

FIG. 3 is a cross-sectional view of the entertainment device of FIG. 1 used with the electronic device of FIG. 1

FIG. 4 is a perspective view of another exemplary embodiment of an entertainment device used in conjunction with the electronic device of FIG. 1 that is different from the embodiment of FIG. 1.

FIG. 5 is a perspective view of another exemplary embodiment of an entertainment device used in conjunction with the electronic device of FIG. 1 that is different from the embodiments of FIG. 1 and FIG. 4.

FIG. 6 is a cross sectional view of an optional attachment feature that can be used with the entertainment device.

FIG. 7 is a cross-sectional view of an optional reflective feature that can be used with the entertainment device.

FIG. 8 is a cross-sectional of the reflective feature illustrated in FIG. 7 in a different configuration to act as a cover for the light emitter.

FIG. 9 is a top view of an optional rotatable member that can be used with the entertainment device.

FIG. 10 is a perspective view of an optional arrangement of multiple of the rotatable member illustrated in FIG. 9.

FIG. 11 is an optional fiber optic feature that can be used with the entertainment device.

FIG. 12 is another embodiment of the entertainment device including a magnetic mounting.

FIG. 13 is an exemplary embodiment of the entertainment device for use with a docking station.

FIG. 14 is an exemplary embodiment of the entertainment device including various optional features.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

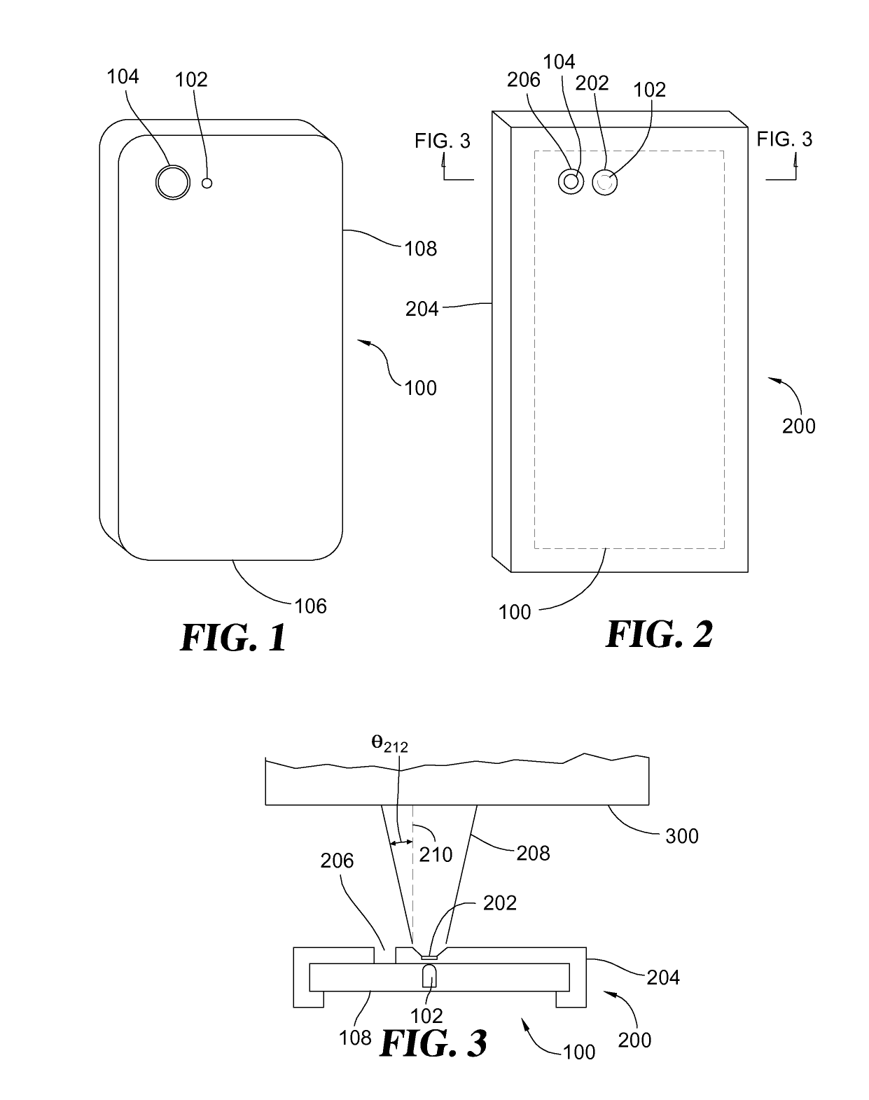

FIG. 1 illustrates an electronic device 100 having an imaging sensor 104, a light source 102, and a body 108. The electronic device 100 illustrated can be a smartphone. Smartphones generally include a microphone 106 that can be used in conjunction with the entertainment device 200 disclosed herein. The light source 102 can take the form of a Light Emitting Diode (LED) or other device. When used in conjunction with an imaging sensor 104, the light source can be used as a flash to momentarily illuminate dark areas and improve the light available to the imaging sensor for capturing images. Alternatively, the light source 102 can be used as a flashlight to constantly provide light. When used as a flash for an imaging sensor, light sources 102 of smartphones generally emit less than eighty lumens of light. When the light source 102 is used constantly as a flashlight, the light source generally emits less than forty lumens in order to prevent overheating and excessive power draw. Other light sources 102 and electronic device 100 are contemplated as well for use with the entertainment device 200, including but not limited to digital cameras, computers (laptop or desktop), wireless phones, tablets, phablets, or others.

FIG. 2 illustrates an entertainment device 200 for use with a mobile electronic device 100. The entertainment device 200 illustrated is a case for a smartphone. The entertainment device 200 illustrated includes a housing 204, aperture 206, and a projection member 202. The aperture 206 prevents interference with the imaging sensor 104 when the entertainment device 200 is coupled to an electronic device 100 having an imaging sensor 104. The housing 204 can be used to removably couple the entertainment device 200 and electronic device 100. The removable coupling between the two devices can enable the entertainment device 200 to be nondestructively removed from the electronic device 100. As illustrated, the projection member 202 is located in the path of light emitted from the light source 102 of electronic device 100 when entertainment device 200 is coupled to electronic device 100.

FIG. 3 illustrates a side cutaway view of the entertainment device 200 mounted to an electronic device 100 as shown in FIG. 2. FIG. 3 illustrates the projection 208 of light that has passed through the projection member 202 onto a planar surface 300. Projection member 202 can be configured to alter the projection angle θ₂₁₂ when referenced to axis 210 that is substantially perpendicular to the surface of the light source 102 or the surface of the projection member 202. θ₂₁₂ can be between ten and sixty degrees to enable projection onto a planar surface. Alternatively or congruently, the projection member 202 can alter the color of light emitted from the light source 102 or can be used to project an image/logo onto the planar surface 300. The projection member 202 can be fully or partially transparent.

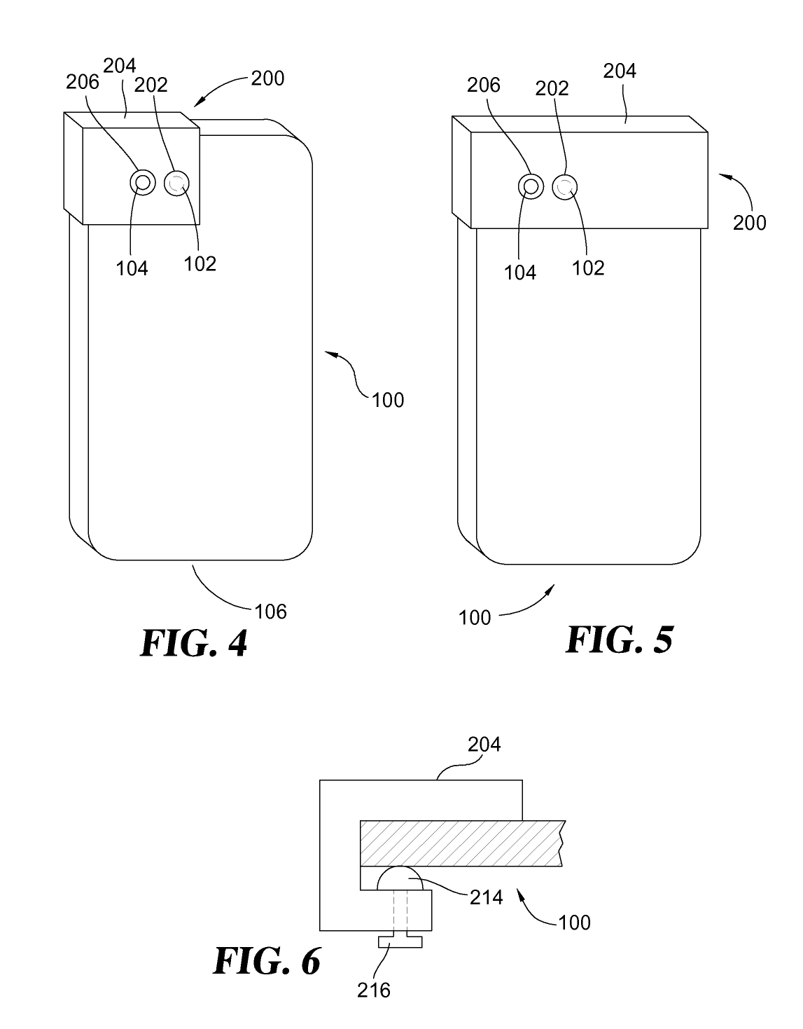

FIG. 4 illustrates an example entertainment device 200 that can couple to a corner of the electronic device 100. The illustrated entertainment device 200 provides flexibility to accommodate for various sizes and shapes of electronic devices 100. The entertainment device 200 of FIG. 4 can also accommodate various smartphone entertainment devices that may have phone cases already attached. FIG. 5 illustrates another exemplary embodiment of the entertainment device that can be used to slide onto an electronic device 100. The illustrated entertainment device 200 of FIG. 5 can be also be used to accommodate various sizes, shapes, and configurations of electronic devices 100.

FIG. 6 illustrates a side cutaway view of the entertainment devices 200 illustrated in FIG. 4 and FIG. 5. The entertainment device can includes an optional elastomeric member 214 positioned between the housing 204 and the electronic device 100 to more securely couple the housing 204 to the electronic device 100. The elastomeric member 214 can also be used to prevent the entertainment device 200 from moving with respect to the electronic device 100 and more consistently align the projection member 202 with the light source 102. Alternatively or in conjunction with the elastomeric member 214, a moveable member 216 can be used to increase the gripping force applied to the electronic device 100 and to more securely couple the two devices. The moveable member 216 can be moveable with respect to the housing 204. The moveable member 216 can be spring loaded, can use a friction fit, or other. As illustrated, the moveable member is a plunger that can be depressed to apply pressure against the elastomeric member 214. Alternative mounting structures can include adhesives, suction cups, or combinations of mounting structures.

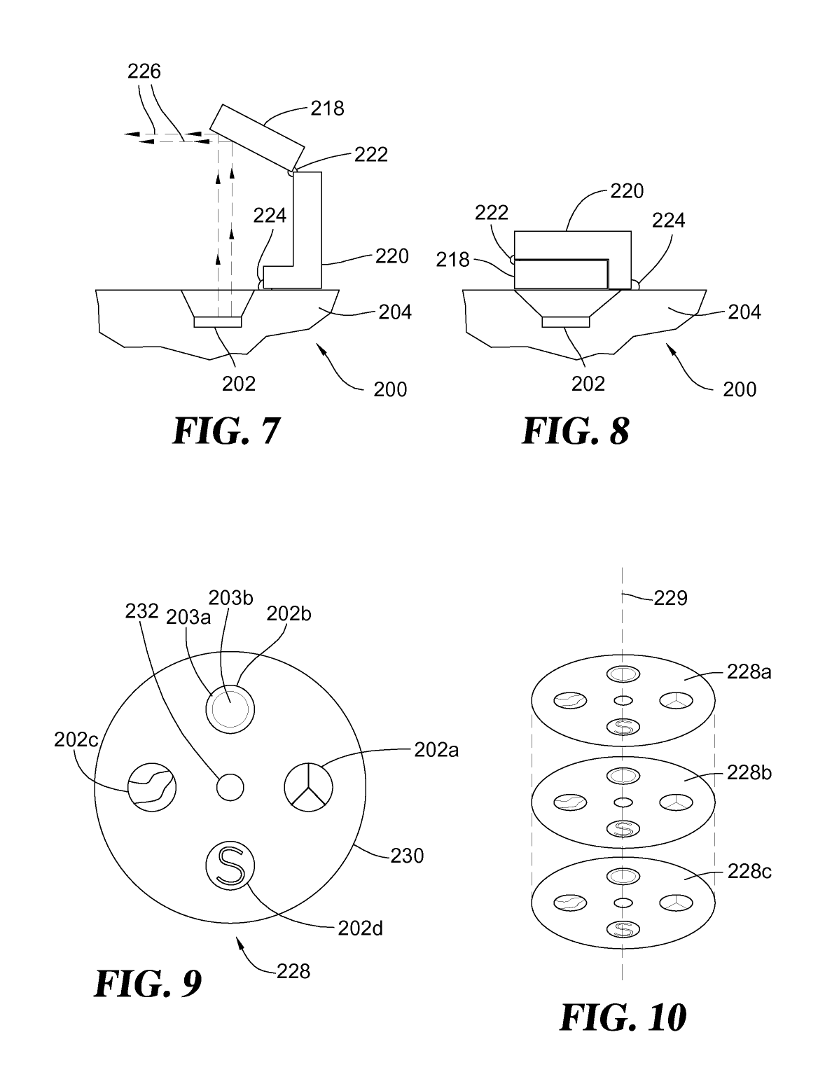

FIG. 7 illustrates a cutaway side view of the entertainment device 200 to illustrate an optional mirror element 218 used in conjunction with the entertainment device 200. The mirror element 218 is illustrated as a being arranged to alter the direction of light rays 226 passing through the projector element 202. The mirror element 218 is illustrated as being moveably mounted to the housing to enable the mirror element 218 to be repositionable and change the direction of light being projected. The moveable mounting is accomplished via the use of hinges 222 and 224 and intermediate member 220. Another novel feature of this arrangement is illustrated in FIG. 8 wherein the mirror element 218 and intermediate member are folded to cover the projector element 202 to prevent inadvertent damage or spoiling of the projector element 202 due to inadvertent contact with the projector element from the exterior of the entertainment device 200.

The mirror element 218 may be colored, engraved, textured, concave/convex, focused, and/or have a surface consisting of multiple mirrored facets (e.g., like a “disco ball”). The mirror may be printed with graphic effects (e.g., logos, promotional advertising) to project the desired images and/or effects. Further, the mirror element 218 may be enclosed and/or incorporate multiple mirrored surfaces or the entertainment device 200 may incorporate multiple mirror elements 218. The mirror element 218 is illustrated as being positioned to redirect light that has already passed through the projection member 202, but the mirror element can be located between the light source 102 and the projection member 202. In this manner, the mirror element 218 can alter the direction of light prior to the light passing through the projection member 202. Additionally, the mirror member can be mounted using a rotational or other mounting instead of or in conjunction with the illustrated hinged mounting.

FIG. 9 illustrates a rotatable member 228 including several different projection members 202a-d. The different projection members 202a-d each illustrate a different exemplary embodiment of projection member 202. Projection member 202a is configured to project a “peace” sign. Projection member 202b is configured to project an annular design with two distinct zones 203a and 203b that can either be different colors, different shades of colors, or even different diffraction patterns. Projection member 202c contains a liquid wherein either different colored solid components are free to move within the liquid or two or more differently colored immiscible liquids are contained within. Projection member 202d illustrates a notional sports team symbol that can be projected. Projection member 202 can be fully or partially transparent and can be engraved, textured, concave/convex, and/or have a surface consisting of multiple transparent facets (“fly eye”). Projection member 202 can also be printed with graphics (logos, promotional advertising, etc.). The rotatable member 228 can be rotated about axis 233 and can enable the selection of an actively projecting member 202 from multiple projection members 202. The body 230 of the rotatable member 228 can act as a thumbwheel to enable easy selection of the projection member 202.

FIG. 10 illustrates several rotatable members 228a-c that are arranged to rotate around a common axis 229. The different rotatable members 228a-c can be arranged such that light emitted from the light source 102 travels through more than one projection member 202. The rotatable members 228 can also be used to create various lighting effects. For example, rotatable member 228a can contain projection members 202 with various angles of projection. Rotatable member 228b can contain various colored filters. Rotatable member 228c can contain various logos or patterns. In this manner, the number of combinations of different light effects is increased. Although four projection members 202 are illustrated for use with each rotatable member 228, any number of projection members 202 can be used.

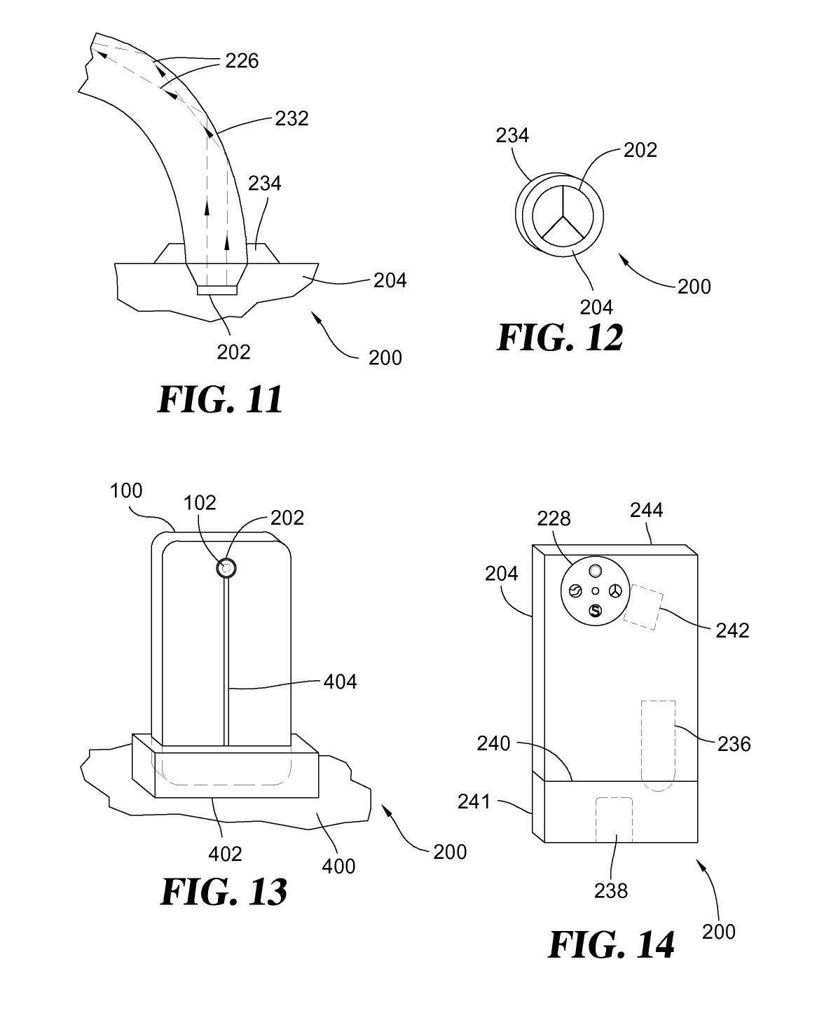

FIG. 11 illustrates a fiber optic element 232 that can be used to alter the direction of light emitted 226 from the light source 102 that passes through the projection member 202. FIG. 11 includes a support element 234 to secure the fiber optic element 232 to the housing 204. The fiber optic element 232 (or the mirror element 218 of FIG. 7) can be used in conjunction with the rotatable member(s) 228 of FIGS. 9 and 10. Additionally, more than one fiber optic element 232 can be used to emit light 226 in several different directions so that light is dispersed in several distinct directions.

FIG. 12 illustrates a projection member 202 mounted to a housing 204 with a magnetic member 235. The magnetic member 235 can be used to removably mount the entertainment device 200 to an electronic device 100 that has a corresponding magnetically reactive exterior or element near the light source 102 (such as a ferrous metal).

FIG. 13 illustrates an alternative embodiment of the entertainment device 200. This embodiment advantageously allows the electronic device 100 to be docked to a vehicle, table top, stereo, or other location. The entertainment device 200 includes a base 400 and a support member 402. The support member 402 includes an extension arm 404 for positioning of the projection member 202 in the path of light emitted from the light source 102. The extension arm 404 and/or support member 402 can be adjustable to accommodate several different variations of electronic devices 100. The entertainment device 200 can includes external speakers, a microphone, a power source, a clock, or other features to complement the electronic device 100.

FIG. 14 illustrates an example of the entertainment device 200 wherein the housing 204 includes a first portion 244 and a second portion 241. The portions 244 and 241 can be removably mounted to each other at, for example, seam 240. The portions 244 and 246 can be mounted via a tab, clip, or other arrangement. Illustrated is a rotatable member 228 coupled to an actuator 242. The actuator is configured and arranged to enable electromechanic selection of the projection member 202 used to project a light effect. The entertainment device of 200 can also include an interface element 238 to enable communicative coupling between the entertainment device 200 and the electronic device 100. Alternatively, the interface element 238 can be used to power the electronic device 100 or the entertainment device 200. Element 236 can be a microprocessor, battery, System On a Chip, FPGA, logic device, Bluetooth™ device, or a combination of electronic devices.

The entertainment device 200 can be used in conjunction with software contained in the electronic device 100 or the entertainment device 200 to automatically vary the light effect projected from the entertainment device 200. Additionally, the entertainment device 200 can include multiple rotatable members 228 as illustrated in FIG. 10 to enable multiple different configurations of light effects between various projection members 202. Each rotatable member 228 can be separately controllable. The selection of a projection member 202 or a combination of projection members 202 can be varied to respond to music emitted by the electronic device 100 such as the beat, tempo, volume, or other characteristics. Alternatively, the selection of the projection member(s) 202 can be pre-defined to emit a specific combination of light effects to coincide with a specific musical piece. The device can also be programmed to alter the intensity of light emitted from the light source 102 in a similar fashion. Additionally, the light source 102 or projection member 202 can be adjusted according to other features including sounds, detected movement, vibrations, or other stimuli. Various software builders can be employed to generate such electronic device software including, for example, the builder disclosed in WO2013109860 A1 published on Jul. 25, 2013 which is hereby incorporated by reference herein in its entirety.

If the electronic device 100 contains a vibration feature, the electronic device can also be programmed to vibrate in response to stimuli. This vibration can cause the entertainment device 200 to vibrate and create different light effects via the vibration. The entertainment device 200 can include spring loaded elements, reflective surfaces, or projection members 202 that respond to the vibration. For example, the projection members 202 can have movable faceted lenses that move when vibrated. The projection members 202 with liquid can also react to the vibration if, for example, they have suspended solid particles inside.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A mobile entertainment accessory device for use with a mobile electronic device having a built-in camera flash, comprising:
a projection member configured and arranged to pass light emitted from a light source of a mobile electronic device;
a housing coupled to the projection member and configured and arranged to removably couple the projection member to a mobile electronic device and position the projection member in the path of light emitted from the light source;
wherein the housing can be non-destructively removed from the mobile electronic device; and
wherein the projection member is further configured and arranged to substantially alter the projected light pattern of the light emitted from the light source.

2. The device of claim 1 wherein the projection member is configured and arranged to project the majority of light emitted by the light source towards a singular planar surface.

3. The device of claim 1, comprising a mirror movably coupled to the housing and configured and arranged to alter the direction of light that has passed through the projection member.

4. The device of claim 1, wherein the projection member includes a color filter.

5. The device of claim 1, wherein the device includes multiple projection members.

6. The device of claim 1, wherein the projection member includes a graphic design.

7. The device of claim 1, wherein the projection member includes a lens configured and arranged to project the majority of light directed towards the projection member substantially at a projection angle of between ten and sixty degrees.

8. The device of claim 5, wherein the multiple projections members are selectable to enable light emitted from the mobile device to pass through different projection members.

9. The device of claim 8, wherein the multiple projection members are selectable to allow light emitted from the mobile device to pass through more than one projection member.

10. The device of claim 8, further comprising a selection member configured and arranged to enable selection between the multiple projection members.

11. The device of claim 10, where in the selection member is a thumbwheel.

12. The device of claim 1, further comprising a magnet coupled to the housing configured and arranged to provide the removable coupling force between the device and the mobile electronic device.

13. The device of claim 1, wherein the mobile electronic device is a smartphone.

14. The device of claim 3, wherein the housing is configured and arranged to position the mirror as a cover to the light member to inhibit direct physical contact of the projection member by a user when the device is coupled to a mobile electronic device.

15. The device of claim 8, wherein the multiple projection members are mounted on a rotatable member.

16. The device of claim 9, wherein the multiple projection members are mounted on multiple rotatable members.

17. The device of claim 1, wherein the housing couples to the mobile electronic device by applying pressure to opposing sides of the mobile electronic device.

18. The device of claim 1, wherein the light source outputs less than eighty lumens.

19. The device of claim 8, further comprising an electromechanical actuation device configured and arranged to select between the projection members.

20. The device of claim 19, further comprising a processor configured and arranged to communicate with the electronic device and receive commands from the electronic device to select different projection members.
